(19) United States
(12) Patent Application Publication
(10) Pub. No.: US 2006/0160483 A1
(43) Pub. Date: Jul. 20, 2006

(54) Coin bag with offset opening

(76) Inventor: David Beck, Crystal Lake, IL (US)

Correspondence Address: Michael H. Baniak;BANIAK PINE & GANNON, Suite 1200, 150 N. Wacker Drive, Chicago, IL, 60201, US

(21) Appl. No.: 11/037,030

(22) Filed: Jan. 17, 2005

(51) Int. Cl. G07D 9/00

(52) U.S. Cl. 453/63

(57) ABSTRACT

A plastic bag for use with a coin sorting machine includes a front panel and a back panel sealed to the front panel. The front and back panels form a storage compartment therebetween and define an opening at an upper margin of the front panel. The opening is sized and shaped to receive coins from the coin sorting machine. The opening extends inwardly from one of a first side margin and a second side margin of the plastic bag and has a width which is less than an entire width of the plastic bag.

### FIELD OF THE INVENTION

The present invention is directed to security bags or pouches and in particular, to plastic security bags, which are used, for example, to receive, store, transport and deliver coins and other similar items.

### BACKGROUND OF THE INVENTION

There are many types of coin sorting and processing machines that sort, count and deposit coins at high speed into coin transport bags attachable thereto. Examples of such machines include those made by De La Rue Cash Systems, for example, the Mach® 12 Plus model. These types of machines are highly efficient at receiving a mixture of coins and separating coins into respective denominations. After sorting and counting, the separated coins are typically directed to a coin transport pouch or bag attached or otherwise associated with a coin exit region of the machine.

Until recently, bags for use with coin sorting machines have been constructed from heavy canvas. The construction of these bags has been dictated at least in part to meet a set of standardized requirements. Standard coin bags are rectangular and include an opening at a top portion thereof that extends across an entire width of the bag. One of those standardized requirements specifies that the bags carry 50 pounds of coins, tokens or the like and remain intact when shifting during transport or dropped from a specified height when full. Other requirements specified by relevant regulatory bodies require that the bags include security measures to provide a tamper evident feature. Many such standard bags include various configurations of seals, including lead seals, for example.

More recently, plastic bags have been developed that meet the specified requirements and cost less than standard canvas coin bags. Typically, these are constructed by positioning front and back panels made of a thermoplastic material into a face-to-face arrangement and heat-sealing the panels together at both side margins and a bottom margin. This forms a pouch with an unsealed opening, which extends across an entire with of a top edge thereof. In the alternate, the pouch may be formed from a single sheet of thermoplastic material folded so as to form front and back panels. In such an example, the panels need only to be sealed at their side margins to form a pouch with three closed borders, i.e., the two side edges and the bottom edge. One of the panels may include a flap, sized and shaped to fold over the other of the panels and is affixed in place to seal the opening after the pouch is filled. The seal provided by the flap is typically provided with a tamper evident feature, which may take any number of known forms, such as a tamper evident adhesive, such as that shown in U.S. Pat. No. 5,405,197, incorporated herein by reference.

FIG. 1 shows a simplified diagram of a conventional coin-sorting machine 10, which typically includes a filler element, bag attachment device or spout 12 at an exit region 14 of the machine. The spout 12 is commonly in the shape of a cylindrical tube or the like or a funnel that is narrower at an upper end 16 thereof and widens gradually to a lower end 18 thereof. Of course, different coin machines have differing filler elements. A typical filler element 12 includes a top portion 16, which is attached to the sorting machine 10. The filler element 12 includes a waist portion 20 along a mid span thereof. The waist portion 20 is provided with an open ring 22, typically having a “C” shape. The lower portion 18 of the filler element 12, from which the coins exit, is typically flared outwardly or provided with a radially extending flange (not shown) or the like, compared to the waist portion 20. The flange or flare provides a locking feature 24 when the ring 22 is lowered.

In use, an opening 32 of a prior art coin pouch 30 is positioned around the periphery or waist portion 20 of the spout 12. The bag 30 is pulled forward so the opening 32 is snugly positioned on the filler element 12. The user lowers the locking ring 22 over the outside of the bag 30 and down against the lower portion 18 of the spout 12. Excess material defining the opening 32 of the bag 30 may be channeled through a gap (not shown) in the C-shaped ring 22.

Older canvas bags were relatively flexible and could easily be manipulated to fit over the spout and inside the machine. Newer plastic bags are made with a minimum of 6.5 mil material and, as a consequence, are very stiff. Thus, the bags are difficult to manipulate around the spout, under the ring and through the gap. Also, the bags are sufficiently stiff to make difficult the task of positioning the excess in the coin-sorting machine. Because of this, it can be difficult for the user to close a security door 28 over one or more coin bag 30, which is necessary due to the value of the coins.

A problem of existing coin bags is related to the difficulty of adapting the fit of the bag to the filler element of the coin-sorting machine. As a result, each bag must be forcefully manipulated into position about a filler element of a coin-sorting machine and is often less secure than desired among other problems.

Another problem is related to a second type of spot. The second type of spout can be found on the De La Rue machine. This type of spout pivots out from where it is attached to the coin-sorting machine. After pivoting outwardly, a part of the opening of the bag is positioned around the spout. The spout and bag are pivoted back into place and lock into place. The bag is held on the spout by C-shaped plastic fingers that surround most of the spout and bag and clamp the bag in place. Each spout has a load sensor to detect when the spout has been pivoted into a locking position to receive coins. The newer plastic bags are also difficult to fit to these spouts and may interfere with the operation of the load sensor.

In summary, current coin bags offer only full width fill openings and seals and this fact, prevent a secure installation of many existing coin sorter/counter bagging attachments and interfere with existing bag security doors.

Therefore, there is a demand for a plastic coin bag that is better adapted to being received on modern coin sorting machines. The present invention satisfies the demand.

### SUMMARY OF THE INVENTION

One aspect of the present invention provides a plastic bag for transporting coins and for use with a coin sorting machine including a front panel and a back panel sealed to the front panel. The front and back panels are sealed together to form a storage compartment therebetween and define an opening at an upper margin of the front panel. The opening is sized and shaped to receive coins from the coin sorting machine. The opening extends inwardly from one of a first side margin and a second side margin of the plastic bag and has a width which is less than an entire width of the plastic bag.

Other aspects of the invention include wherein the front panel is sealed together by a continuous pouch seal to the back panel and includes a first vertical seal portion along a first edge of the bag and a second vertical seal portion along a second edge of the bag and a bottom seal portion spaced inwardly from a bottom edge of the bag. The first vertical seal portion may turn inwardly toward a mid portion of the bag near the upper margin of the front panel and continues vertically to the upper margin to define a spout sized and shaped to be received on the filler element. The plastic bag may further include a receipt portion positioned adjacent the spout. The front panel and the back panel may be formed from a single sheet of plastic. The front panel and the back panel may be formed from two sheets of plastic.

The plastic bag may further include a second seal positioned beneath the bottom seal and a lower margin of the bag and an opening formed through the bag inside the second seal, the opening sized and shaped to receive some or all of a user's hand for carrying the bag. The pouch seal is preferably tamper evident. The front panel and the back panel may be made of 6.5 mil plastic. The plastic bag preferably includes an adhesive positioned on the front panel below the spout such that when the spout contacts the adhesive the pouch is secured in a closed condition. The plastic bag may further include a cover sheet over the adhesive, which exposes the adhesive for use when the cover sheet is removed. The width of the opening may be about half the width of the bag. The width of the adhesive is preferably equal to a width of the spout.

The invention provides the foregoing and other features, and the advantages of the invention will become further apparent from the following detailed description of the presently preferred embodiments, read in conjunction with the accompanying drawings. The detailed description and drawings are merely illustrative of the invention and do not limit the scope of the invention, which is defined by the appended claims and equivalents thereof.

### BRIEF DESCRIPTION OF THE DRAWINGS

FIG. 1 is a side view of a prior art coin pouch positioned in a coin-sorting machine.

FIG. 2 is a front view of one embodiment of a coin bag according to the present invention.

FIG. 3 is a side view of a coin-sorting machine with a coin pouch according to one embodiment of the present invention in place.

FIG. 4 is a side view of another embodiment of a coin bag according to the present invention.

FIG. 5 is a side view of yet another embodiment of a coin bag according to the present invention.

FIG. 6 is a side view of yet another embodiment of a coin bag according to the present invention.

FIG. 7 is a side view of yet another embodiment of a coin bag according to the present invention.

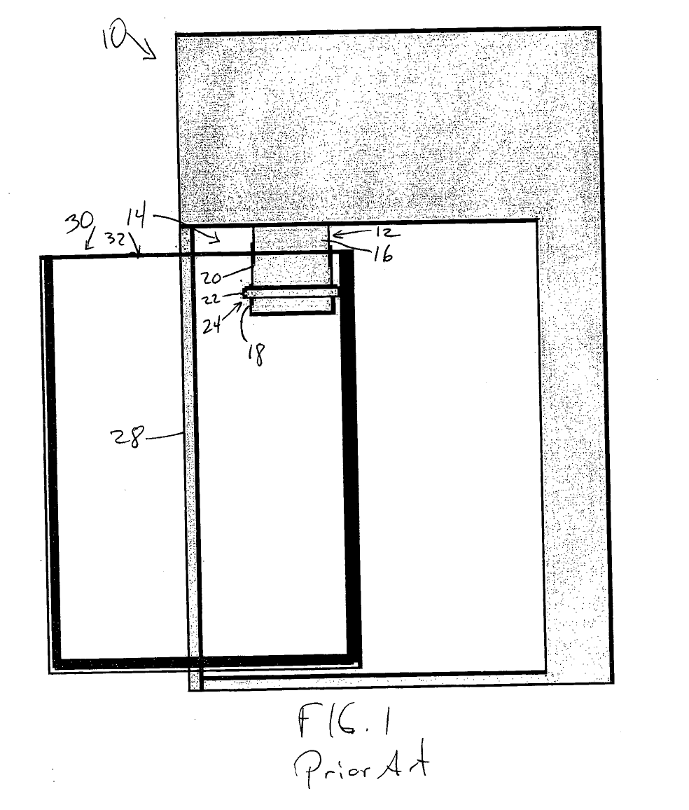

### DETAILED DESCRIPTION OF THE PRESENTLY PREFERRED EMBODIMENTS

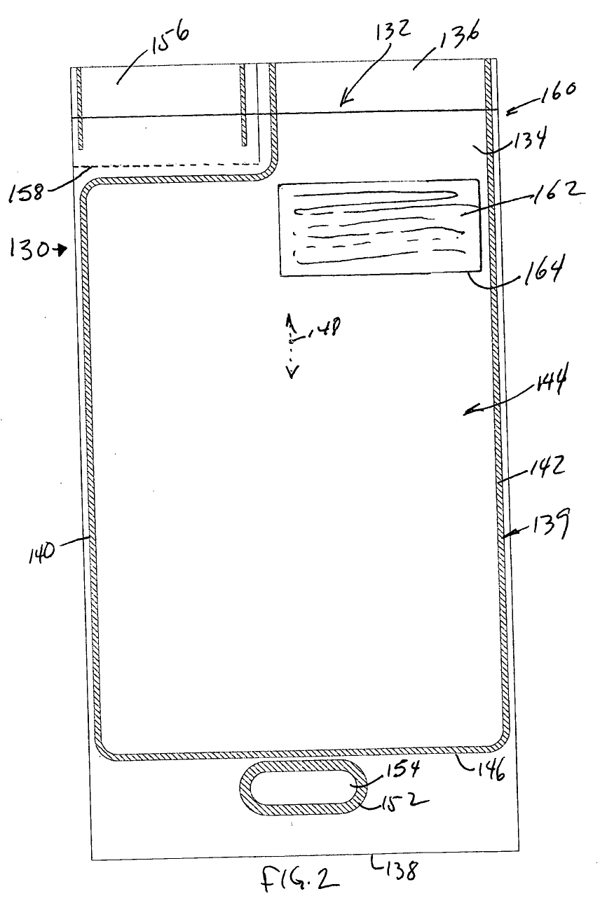

Referring to FIG. 2, one exemplary embodiment of a coin bag according to the present invention is shown generally at 130. It will be understood that use of terms related to positional orientation such as left, right, front, back, top and bottom, etc., are intended to be illustrative in nature and not limiting and refer to the orientation of elements in the drawings provided herein.

The bag 130 includes a front panel 134 generally superimposed with a back panel 136. While the bag 130 may be formed of two separate sheets of plastic material, preferably the front and back panels 134, 136 are formed of a single sheet of plastic material, such as, for example, 6.5 mil low-slip polyethylene or any suitable single or multi-layered plastic. The single layer is folded over so as to form a matching face-to-face or front and back configuration or relationship. In this manner, a closed bottom margin 138 of the bag may be formed without the step or expense of forming a bottom seal, which may provide cost and strength advantages over a bag formed by sealing together two separate sheets of plastic.

Further, in the illustrated embodiment, the back panel 136 is taller and extends upwardly a greater distance than the front panel 134. In this manner, when the bag 130 is closed by folding the front and back panels 134, 136 downwardly, both panels are secured in place as will be explained in more detail below.

To form the coin storage compartment portion 144 of the bag 130, the front and back panels 134, 136 are secured together by a continuous pouch seal 139. Preferably the pouch seal is 3/16 inches wide. The pouch seal 139 may be formed by heat sealing or by a suitable adhesive. It will be understood that the seal 139 should be formed so that it may not be broken and reformed without detection. The pouch seal 139 and front and back panels 134, 136 together define the storage compartment 144, which is sized and shaped to contain at least fifty pounds of a denomination of coins. The pouch seal 139 includes a first vertical seal 140 and a second vertical seal 142 along respective side edges of the bag. Spaced from the bottom margin 138 is a bottom seal portion 146 of the seal 139. Near the top of the bag 130 the pouch seal 139 turns in towards a midpoint 148 of the bag and then back vertically to define an offset opening 132 of the bag that spans about half of the width of the top of the bag 130. The offset opening 132 communicates with the storage compartment 144.

An oval seal 152 positioned between the bottom margin 138 and the bottom seal 146 defines an oval opening 154, which is sized and shaped to be usable as a handle. The seal 152 may be a heat seal.

On a top portion of the bag 130 outside the pouch seal 139 and opposite the offset opening 132 is a receipt section 156 of the bag. The receipt section 156 is removable from the bag 130 by a line of weakened material 158.

Bag 130 has a suitable tamper evident closure. The front panel or sheet 134 has a section of adhesive 162 below the offset opening 132. Before use, a cover sheet 164 protects the adhesive 162. Once the bag 130 has been filled and the receipt 156 filled out and detached by way of line of weakened material 158, a filler portion 160 of offset opening 132 is folded downwardly upon the front sheet or panel 134. Removal of the cover sheet 164 exposes the section of adhesive 162 and the back panel 136 is adhered to the adhesive 162. The bag 130 is effectively permanently sealed thereby.

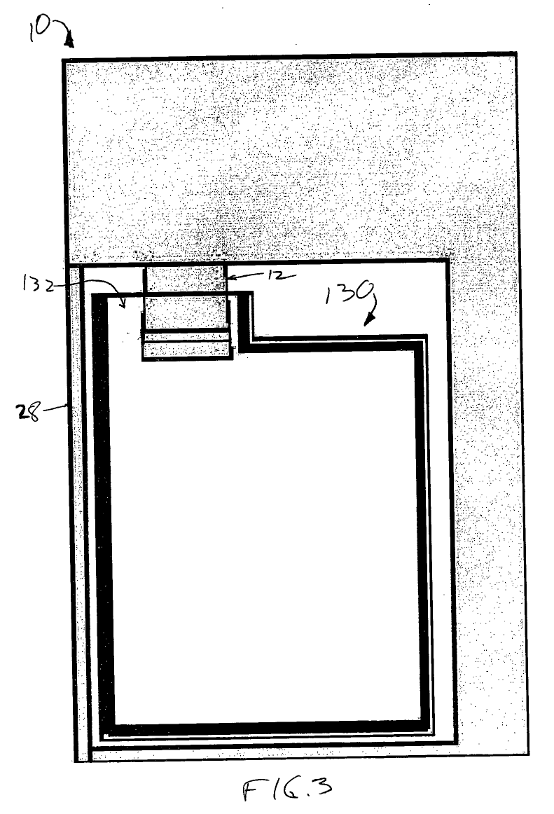

FIG. 3 illustrates the bag of FIG. 2 positioned within a conventional coin-sorting machine 10. The offset opening 132 of the bag 130 is positioned around the filler member 12. The entirely of the bag 130 is within the confines of the machine 10 enabling a security door 28 to be closed during the operation of the machine.

As mentioned above, a coin bag according to the present invention may take a number of shapes. It will be recognized that an important feature common to all embodiments of the invention is the offset opening or spout 132 (See FIG. 2) of the bag, which is sized and shaped to closely fit to a filler member of a coin sorter or like device.

Turning to FIG. 4, a bag 230 may be formed with an offset spout 232 extending from a first seal 240. A front sheet 234 of the bag 230 forming the spout 232 may include a line of weakened material 266. When full, the front sheet 234 is removed along the line 266 and a back sheet 236 of spout material is folded over an area of adhesive 262 to close the bag 230. A handle 254 is formed along an area defined between a second side seal 242 and the right edge 268 of the bag 230. The bag 230 right edge 268 may include an inclined portion 272 from the spout 232.

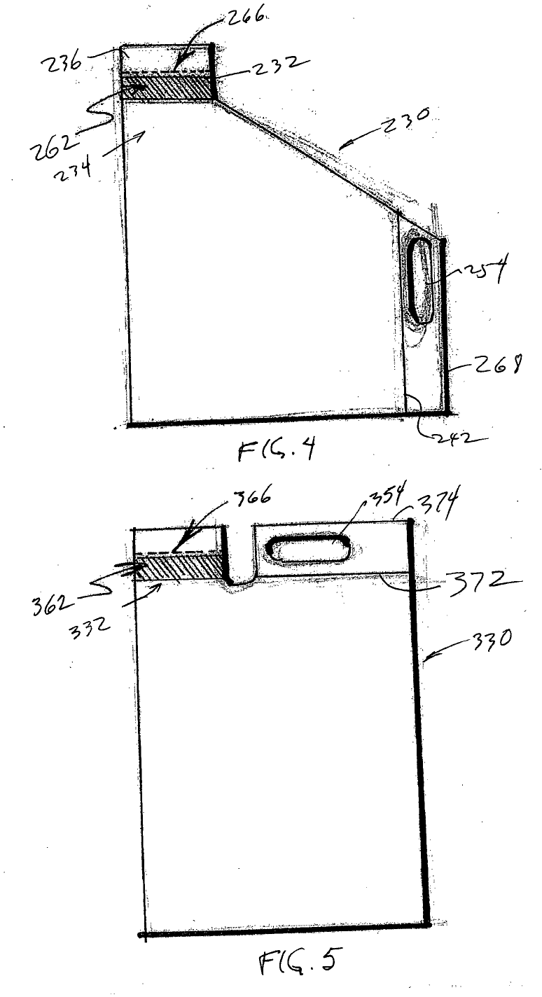

Turning to FIG. 5, a bag 330 is shown similar to that in FIG. 4 with respect to the orientation of the spout 332, line of weakened material 366 and adhesive 362. The bag 330 includes a handle 354 defined between an upper seal 372 and an upper edge 374 of the bag. The overall shape of the bag 330 of this embodiment is rectangular.

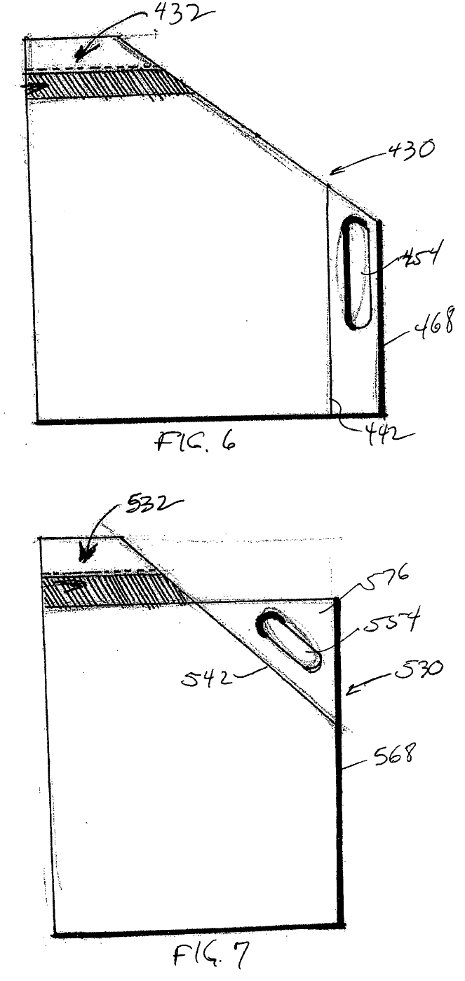

Turning to FIG. 6, a bag 430 is shown similar to that in FIG. 4 with the difference being that the inclined portion of right side 468 continues along the spout 432. The handle 454 remains between seal 442 and right side 468.

Turning to FIG. 7, a bag 530 is shown similar to that in FIG. 6 with spout 532 being formed as a portion of the width of the bag 530. The inclined portion of right side 568 includes a triangular flap 576 with handle 554 formed therein.

The bags of the foregoing examples may be 13 inches wide. The spouts may be along an edge, but may also be formed centrally, and spanning a distance of about half of less than the width of the bag. The exemplary spout shapes are preferably sized and shaped to accommodate closely different coin-sorter filler spouts.

It should be understood that the above description of the preferred embodiment, alternative embodiments, and specific examples are given by way of illustration and not limitation. For example, the features described herein could be incorporated into any variation of a coin bag. Many changes and modifications within the scope of the present embodiments may be made without departing from the spirit thereof, and the present invention includes all such changes and modifications.

I claim:

1. A plastic bag for transporting coins and for use with a coin sorting machine, comprising:
a front panel,
a back panel sealed to said front panel to form a storage compartment therebetween and defining an opening at an upper margin of said front panel, said opening sized and shaped to receive coins from the coin sorting machine, said opening extending inwardly from one of a first side margin and a second side margin of said plastic bag and including a width which is less than an entire width of said plastic bag.

2. The plastic bag of claim 1, wherein said front panel is sealed to said back panel by a continuous pouch seal including a first vertical seal portion along a first edge of said bag and a second vertical seal portion along a second edge of said bag and a bottom seal portion spaced inwardly from a bottom edge of said bag.

3. The plastic bag of claim 2, wherein said first vertical seal portion turns inwardly toward a mid portion of the bag near said upper margin of said front panel and continues vertically to said upper margin to define a spout sized and shaped to be received on the filler element.

4. The plastic bag of claim 3, further comprising a receipt portion positioned adjacent said spout.

5. The plastic bag of claim 4, wherein said receipt portion is separable from said bag by a line of weakened material.

6. The plastic bag of claim 1, wherein said front panel and said back panel are formed from a single sheet of plastic.

7. The plastic bag of claim 1, wherein said front panel and said back panel are formed from two sheets of plastic.

8. The plastic bag of claim 2, further comprising a second seal positioned beneath said bottom seal and a lower margin of said bag and an opening formed through said bag inside said second seal, said opening sized and shaped to receive some or all of a user's hand for carrying said bag.

9. The plastic bag of claim 2, wherein said pouch seal is tamper evident.

10. The plastic bag of claim 2, wherein said front panel and said back panel are made of 6.5 mil plastic.

11. The plastic bag of claim 3, wherein an adhesive is positioned on said front panel below said spout such that when said spout contacts said adhesive said pouch is secured in a closed condition.

12. The plastic bag of claim 11, further comprising a cover sheet over said adhesive, which exposes said adhesive for use when said cover sheet is removed.

13. The plastic bag of claim 1, wherein said width of said opening is about half the width of said bag.

14. The plastic bag of claim 11, wherein a width of said adhesive is equal to a width of said spout.
